(19) United States
(12) Patent Application Publication
(10) Pub. No.: US 2008/0308494 A1
(43) Pub. Date: Dec. 18, 2008

(54) Fluid sampling interface apparatus

(75) Inventor: George E. Barringer, JR., West Groton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Groton Biosystems, LLC

(21) Appl. No.: 12/156,441

(22) Filed: May 29, 2008

Related U.S. Application Data
(60) Provisional application No. 60/932,339, filed on May 30, 2007.

(51) Int. Cl. B01D 35/22; B01D 36/02

(52) U.S. Cl. 210/636; 210/806; 210/335; 210/143; 210/198.1; 210/649; 210/791

(57) ABSTRACT

A sampling apparatus and method for sampling is provided that achieves automatic, aseptic, extractive sampling of fluid samples from fluid sources containing high solids and/or high viscosity fluid without failing due to adverse interactions between the fluid and the sampling device such as clogging or fouling due to mechanical means or to physicochemical reactions between the fluid and the materials of construction of the sample device.

### RELATED APPLICATION

This application describes an apparatus for fluid sampling for high solids or high viscosity fluid samples and claims the benefit of U.S. Provisional Application No. 60/932,339, filed on May 30, 2007. The entire teachings of the above application is incorporated herein by reference.

### BACKGROUND OF THE INVENTION

The use of sampling devices in biotechnology operations is a vital component in ensuring product quality and process efficiency. Most biotechnology sampling systems must maintain a leak-free, sterile connection to the fluid source. The degree of performance repeatability and sterility of the system can be improved if the sampling device is automatically controlled to make either a continuous stream or time programmed aliquot of fluid available to a destination analytical device.

Sampling systems that are amenable to automation have been described in the literature and demonstrated in practice. These include, but are not limited to, in-situ filter probes utilizing 0.22 um effective pore size membranes; peristaltic pumps operated continuously with or without benefit of in-situ filter probes; connections made with weldable plastic tubing; and arrays of automatic valves that permit chemical sanitation in place of all connections between the bioreactor and external devices between sample collections.

Limitations of these systems are well known to practitioners skilled in the art. For example, fluid samples of either high solids content or of high viscosity or both high solid and high viscosity may preclude use of automatic sampling systems that rely on valves or in situ filters. It is well known that in-situ probes that depend on filtering fluid through a membrane having small pores to maintain sterility foul in use and clog frequently when exposed to samples with high solids content. Systems that are designed to use isolation valves may suffer leakage or damage to the valve seats if exposed to high solids containing fluids and therefore suffer subsequent loss of sterility.

Many fluids in commercial biotechnology applications contain a high percentage of solids in suspension or highly viscous components, and can exist as a multiphasic (i.e., containing solid particles, lipid, and aqueous phases) solution or emulsion that is not be compatible with a single filter membrane of uniform hydrophobic or hydrophilic composition. Thus selection of a single filter material which is compatible with the sample may be difficult in practice. It has been observed that lipid phases in aqueous solutions will effectively “waterproof” most hydrophilic filters, rendering them impermeable to the aqueous phase of the sample. Use of hydrophobic filters, may have equivalent compatibility issues with highly aqueous samples exhibiting low permeability due to undesirable surface tension interactions between the water molecules in the solution and the filter surface leading to low flow rates. Accordingly, it is difficult if not impossible to select a single filter to successfully filter a polydisperse, multiphasic liquid sample.

What is needed is a system that achieves automatic, aseptic, extractive sampling of fluid samples from fluid sources containing high solids and/or high viscosity fluid without failing due to adverse interactions between the fluid and the sampling device, such as clogging or fouling due to mechanical means or to physiochemical reactions between the fluid and the materials of construction of the sample device.

### SUMMARY OF THE INVENTION

In one aspect, the present invention relates to an apparatus for filtering a fluid sample, comprising an inlet adapted for fluid communication with a fluid sample source; a first valve positioned to receive the fluid sample from the inlet and coupled to a drain; at least one phase neutral filter positioned to receive the fluid sample from the first valve to filter one or more solid components from the fluid sample; a second valve positioned to receive the fluid sample from the phase neutral filter and coupled to the drain; at least one phase selective filter positioned to receive the fluid sample from the second valve and to separate one of a hydrophilic phase and a hydrophobic phase from the fluid sample; and an outlet.

In another aspect, the present invention relates to an apparatus for filtering a fluid sample from a fluid sample source, comprising at least one phase neutral filter to filter one or more solid components from the fluid sample and at least one phase selective filter to separate one of a hydrophilic phase and hydrophobic phase from the fluid sample, the phase neutral filter preceding the phase selective filter along a fluid channel with respect to the fluid sample source.

In another aspect, the present invention relates to a sampler for acquiring fluid samples from a fluid sample source, comprising a sampling loop channel having a first fluid port adapted for fluid communication with the fluid sample source and a second fluid port adapted for fluid communication with the fluid sample source; a pre-filter to filter solid particles from the fluid; a reversible pump along the sampling loop channel; and a sampling tap in the sampling loop channel.

In another aspect, the present invention relates to an apparatus for breaking up solid particle clusters in a fluid sample, comprising an inlet that receives the fluid sample from a fluid sample source; a strainer that receives the fluid sample from the inlet; a check valve that receives fluid from the strainer; and a pressure source between the strainer and the check valve that reciprocates the flow direction of the fluid sample through the strainer.

In another aspect, the present invention relates to a system for sampling a fluid sample comprising a sampling loop channel having a first fluid port adapted for fluid communication with the fluid sample source and a second fluid port adapted for fluid communication with the fluid sample source; a pre-filter to filter solid particles from the fluid; a reversible pump along the sampling loop channel; a sampling tap in the sampling loop channel; a strainer that receives the fluid sample from the sampling tap; a check valve that receives fluid from the strainer; a pressure source between the strainer the check valve that reciprocates the flow direction of the fluid sample through the strainer; a first valve positioned to receive the fluid sample from the check valve and coupled to a drain; at least one phase neutral filter positioned to receive the fluid sample from the first valve to filter one or more solid components from the fluid sample; a second valve positioned to receive the fluid sample from the phase neutral filter and coupled to the drain; and at least one phase selective filter positioned to receive the fluid sample from the second valve to separate one of a hydrophilic phase and a hydrophobic phase from the fluid sample.

In another aspect, the present invention relates to a method for filtering a fluid sample from a fluid sample source, comprising the steps of passing the fluid sample through at least one phase neutral filter to filter one or more solid components from the fluid sample and then passing the fluid sample through at least one phase selective filter to separate one of a hydrophilic phase and a hydrophobic phase from the fluid sample.

In another aspect, the present invention relates to a method for pre-filtering a fluid sample comprising the steps of circulating a fluid sample from a fluid sample source through a sampling loop channel having a pre-filter in a forward flow direction, the fluid sample entering the sampling loop channel through a first fluid port and returning to the fluid sample source through a second fluid port; allowing solid particle clusters from the fluid sample to accumulate on the pre-filter as the fluid sample is circulated in the direction of forward flow; and removing the accumulated solid particles on the pre-filter by reversing the flow direction for a duration insufficient for a non-pre-filtered fluid sample to reach a sampling tap in the sampling loop channel.

In another aspect, the present invention relates to a method for breaking up solid particles in a fluid sample, comprising the steps of allowing a fluid sample to enter a fluid line having a strainer; and reciprocating the flow direction of the fluid sample.

In another aspect, the present invention relates to a method comprising the steps of prefilling a fluid channel with an incompressible fluid; opening fluid communication between the fluid channel and a fluid sample source; allowing a fluid sample to flow into the fluid channel by controlling the flow rate of the incompressible fluid through the fluid channel; passing the fluid sample through a phase neutral filter along the fluid channel to filter one or more solid components from the fluid sample; passing the fluid sample through a phase selective filter along the fluid channel to filter one of a hydrophilic phase and a hydrophobic phase from the fluid sample; passing the fluid sample to an analysis module; closing fluid communication between the fluid channel and the fluid sample source; allowing a cleaning fluid to flow through the phase selective filter along the fluid channel to a drain the cleaning fluid flowing in a direction opposite the flow direction of the fluid sample from the fluid sample source, to flush residue from the phase selective filter; and allowing the cleaning fluid to flow through the phase neutral filter along the fluid channel to a drain, the cleaning fluid flowing in a direction opposite the flow direction of the fluid sample from the fluid sample source, to flush residue from the phase neutral filter.

In another aspect, the present invention relates to a method comprising the steps of circulating a fluid sample from a fluid sample source through a sampling loop channel having a pre-filter in a direction of forward flow, the fluid sample entering the sampling loop channel through a first fluid port and returning to the fluid sample source through a second fluid port; allowing solid particles from the fluid sample to accumulate on the pre-filter as the fluid sample is circulated in the flow direction; removing the accumulated solid particles on the pre-filter by reversing the flow direction for a duration insufficient for a non-pre-filtered fluid sample to reach a sampling tap in the sampling loop channel; allowing pre-filtered fluid sample to enter a fluid line through a sampling tap, the fluid line having a strainer; reciprocating the flow direction of the fluid sample; allowing the fluid sample to flow into the fluid channel by controlling the flow rate of an incompressible fluid through the fluid channel; passing the fluid sample through a phase neutral filter along the fluid channel to filter one or more solid components from the fluid sample; passing the fluid sample through a phase selective filter along the fluid channel to filter one of a hydrophilic phase and a hydrophobic phase from the fluid sample; passing the fluid sample to an analysis module; allowing a cleaning fluid to flow through the phase selective filter along the fluid channel to a drain, the cleaning fluid flowing in a direction opposite the flow direction of the fluid sample from the fluid sample source, to flush residue from the phase selective filter; and allowing the cleaning fluid to flow through the phase neutral filter along the fluid channel to a drain, the cleaning fluid flowing in a direction opposite the flow direction of the fluid sample from the fluid sample source, to flush residue from the phase neutral filter.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram illustrating an embodiment of the invention;

FIG. 2 is a diagram illustrating various methods for reciprocating flow;

FIG. 3 is a diagram illustrating the sampling loop of the invention in detail;

FIG. 4 is a diagram illustrating a modular system though which a fluid sample is acquired, processed, and analyzed;

FIGS. 5a-5e illustrate various views of one embodiment of the HSI module

FIG. 5a is an exploded isometric side view,

FIG. 5b is an isometric side view,

FIG. 5c is a side view,

FIG. 5d is an isometric top view,

FIG. 5e is a top view.

FIG. 6 is a diagram illustrating a configuration for a particular embodiment of the HSI module.

### DETAILED DESCRIPTION OF THE INVENTION

### Sampling System

The present invention relates generally to the field of biochemical analysis and specifically to devices and methods to make and maintain sterile connections to cell culture and fermentation vessels (“bioreactors”) for the purpose of enabling on-line, automatic sampling of said vessels. The present invention is particularly suited for sampling high solids and or highly viscous fluids, which can be multiphasic and typically contain particles of a wide range of diameters and shape.

Corn mash (raw or cooked ground corn) is used as a feedstock in ethanol fermentation and is a good, but not only, example of a bioreactor fluid sample that is both polydisperse and multiphase. A typical corn mash sample contains particles ranging in size from micrometers to 2-3 mm in addition to dissolved starch, dissolved minerals and nutrients in the aqueous phase, and corn oil. This combination of particle sizes and fluids phases in a complex sample such as corn mash effectively foils use of simple filter systems in automatic bioreactor sample systems. This is because the range of particle sizes permits formation of a “well cemented” and impermeable or low permeable filter cake on the surface of the filter that impedes fluid flow. The present invention is well suited for sampling fluids, such as corn mash, which are polydisperse and multiphasic

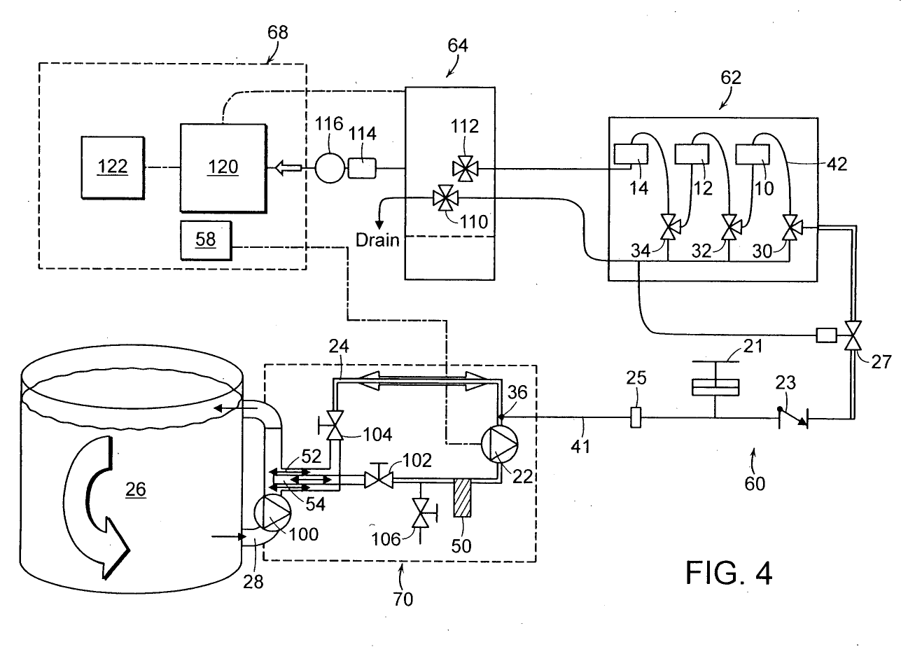

FIG. 4 shows a system though which a fluid sample is acquired, processed, and analyzed. The system includes several modules: a sampling loop module 70; an alternating fluid module 60, a High Solids Interface, or “HSI” module 62; an Automatic Reactor Sample, or “ARS” module 64 (described in U.S. Patent Application Publication No. 2004-0259266, herein incorporated by reference in its entirety); and an analysis module 68.

As shown in the embodiment of FIG. 4, a sample is acquired from the sample source vessel 26 via the sampling loop module 70. A recirculation line 28 stirs fluid in the sample source vessel by using recirculation pump 100 to recirculate fluid through recirculation line 28. The sampling loop module 70 ties into the recirculation line 28. As shown in the embodiment of FIG. 4, the sampling loop module 70 includes a sampling loop channel 24, strainer 50, fluid ports 52 and 54, optional manual emergency shutoff valves 102 and 104 for closing fluid communication through the sampling loop, and optional manual sample valve 106 for extracting a fluid sample. The sample loop module further includes a reversible pump 22.

The sample passes from the sampling loop 70 to an alternating fluid line 41 in the alternating fluid module 60, where the fluid is first passed through strainer 25, and then reciprocated by alternating pump 21 to break up particle agglomerations in the fluid. The fluid passes through check valve 23 and then exits the alternating fluid module through an isolation valve 27.

After passing through isolation valve 27, the fluid sample undergoes a filtering operation in the HSI module 62. In the embodiment shown in FIG. 4, the fluid sample passes through filters 10, 12, and 14, and valves 30, 32, and 34. The valves provide a fluid pathway to a drain through drain isolation valve 110 in the ARS module 64, and also provide a pathway to a reactor valve 112 in ARS module 64.

The fluid proceeds to ARS module 64, where the sample is further processed optionally for protein separation, denaturing, and other treatment. Once the processing of the sample is complete, the sample flows through disposable filter 114 and optional rheodyne valve 116 to the analysis module 68. The analysis module shown in the embodiment of FIG. 4 includes an analyzer 120, such as a high performance liquid chromatography (HPLC) system, and further includes a controller 122. In the embodiment of FIG. 4, controller 58 for the reversible pump 22 also resides in the analysis module 68.

Novel features are presented in the sampling loop module, the alternating fluid module and the HSI module of the system.

### HSI Module

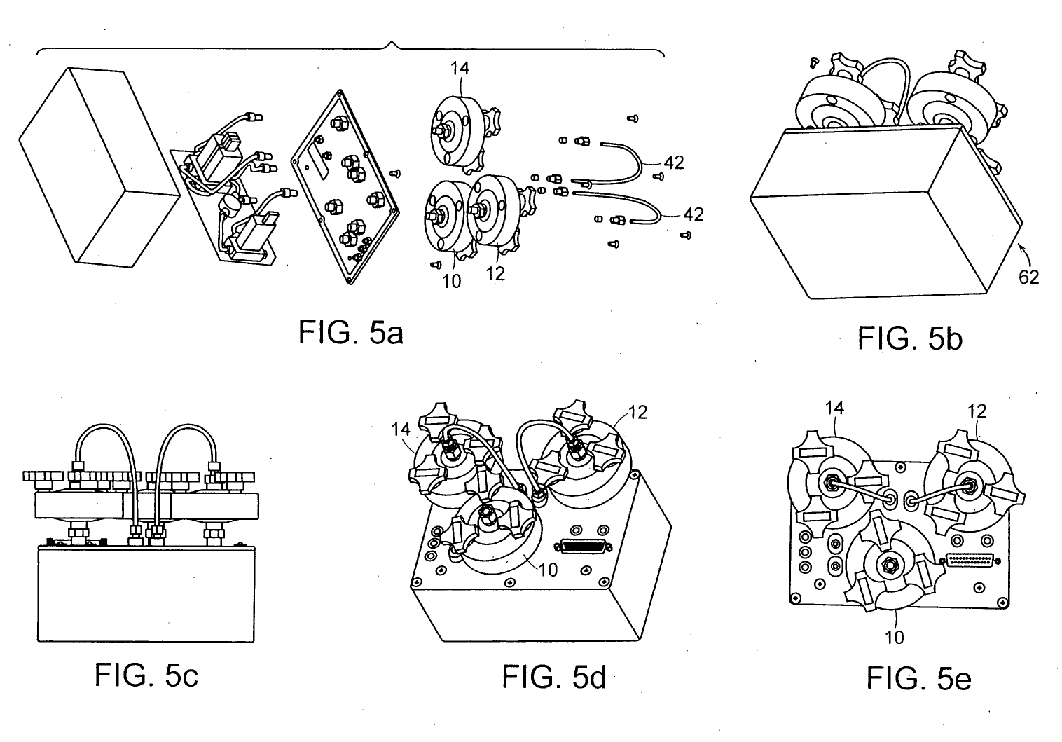

The HSI module 62 includes a series of filters along a fluid channel, capable of filtering a highly viscous, solids laden, multiphasic sample. To prevent adverse interactions between the fluid and the sampling device, such as clogging or fouling due to mechanical and/or chemical means, the HSI module 62 can perform a cleaning operation between each filtering operation. An embodiment of the HSI module is shown in FIGS. 5a-5e.

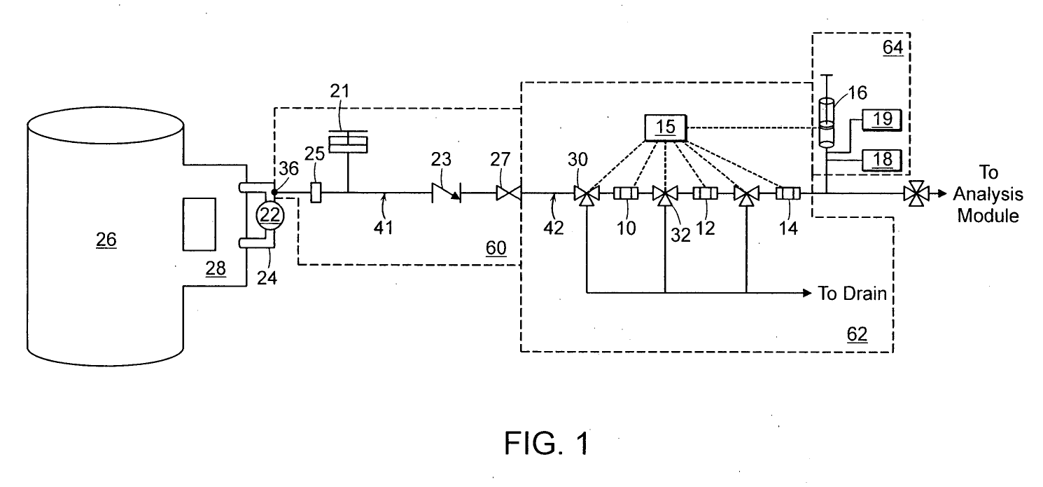

Referring to FIG. 1, the HSI module 62 includes a fluid channel 42 in fluid communication with an upstream fluid source 26 (via alternating fluid module 60, sampling loop module 70, and recirculation line 28). Fluid channel further includes an inlet and outlet for fluid communication with a drain and with other modules, such as ARS module 64, which includes pump 16, cleaning fluid reservoir 18, incompressible fluid reservoir 19. As used herein, the term “fluid communication” refers to a relationship between two components whereby fluid can flow from one component to the other. As used herein, the term “drain” refers to one or more drains.

Positioned along the fluid channel 42 is at least one phase neutral filter and at least one phase selective filter. As used herein, the term “phase neutral” means comprising a material that is not phase selective of either hydrophobic or hydrophilic components of the sample. Preferably, the HSI includes more than one phase neutral filter. In the embodiment shown in FIG. 1, filters 10 and 12 are phase neutral filters. Although FIG. 1 shows two phase neutral filters, more phase neutral filters can be introduced along the fluid channel as needed to screen solid particles from the fluid sample.

The phase neutral filters remove solid particles from the fluid sample and are arranged in series, with each phase neutral filter having a finer pore size than the phase neutral filter preceding it. Thus, the fluid sample from the fluid sample source first reaches a phase neutral filter that screens out course particles and then passes to a subsequent phase neutral filter that screens out finer particles.

In addition to the phase neutral filters, a phase selective filter 14 is also positioned along the fluid channel 42. As used herein, “phase selective” means comprising a material that is capable of selecting one of a hydrophobic phase and a hydrophilic phase from a sample. Thus, a hydrophobic phase selective filter will allow preferentially a lipid (hydrophobic) phase to pass through, while a hydrophilic phase selective filter will allow preferentially an aqueous (hydrophilic) phase to pass through. With respect to the fluid sample source, the one or more phase neutral filters 10 and 12 precede the phase selective filter 14. Thus, fluid sample from the fluid sample source 26 passes first through the phase neutral filters 10 and 12, and then through the phase selective filter 14.

Fluid flow through the fluid channel 42 is controlled by a hydraulic system under the control of automatic controller 15. The hydraulic system includes a pump and one or more valves positioned along the fluid channel. For example, the hydraulic system of the embodiment shown in FIG. 1 comprises pump 16 and valves 30, 32, and 34, positioned along the fluid channel. A valve of the automated hydraulic system is provided for each of the filters along the fluid channel. As used herein, the term “valve” refers to a valving system, and may include one or more components that serve a function of opening and closing fluid communication between components. Thus, components that are separated by a closed valve are in closed fluid communication, while components separated by an open valve are in open fluid communication. As shown in FIG. 1, valves 30, 32, and 34 are preferably 3-way valves that each precede (with respect to the fluid sample source) one of the filters along the fluid channel and connect to a drain.

During a sampling operation, the 3-way valves can be oriented to maintain fluid communication between the fluid sample source and the pump (via fluid channel 42, alternating fluid line 41, sampling loop channel 24, and recirculation line 28), so that the fluid sample can pass through the filters. During a cleaning operation that will be described later, the 3-way valves can be controlled to allow fluid sample to flow to a drain in the ARS module or to allow fluid sample to flow upstream up to valve 30.

Once the fluid sample has passed through the phase neutral filters, the sample should be substantially free of solid particles. The sample then passes downstream from the phase neutral filters to at least one phase selective filter. The material of the phase selective filter will depend on whether the desired component of the fluid sample is lipid or aqueous. Filters made from hydrophobic materials, such as polytetrafluoroethylene, or “PTFE,” will allow preferentially hydrophobic phases to pass, while filters made from hydrophilic materials, such as cellulose, polyvinylidene fluoride, or nylon, will allow preferentially hydrophilic phases to pass.

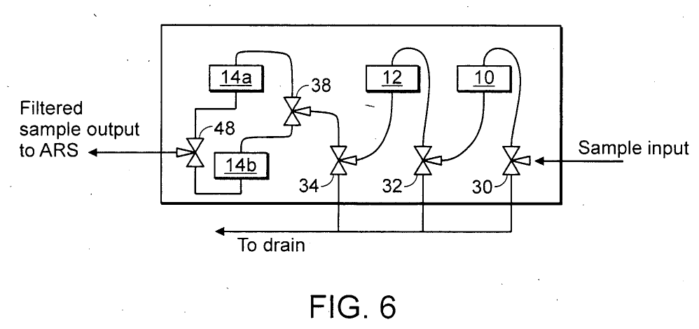

In one embodiment of the invention, the HSI module can include two phase selective filters in parallel. For example, FIG. 6 shows two phase selective filters 14a and 14b in parallel, with one of the filters being preferential to hydrophobic phases and the other filter being preferential to hydrophilic phases. Such a configuration allows the user to toggle between selection of the lipid phase and the aqueous phase of the fluid sample using valve 38, depending on which component is desired.

The filters should be selected for porosity (screen size) and material to maximize flow rate without degrading (clogging) the filter for the desired volume of the sample filtered or time period for which the filter must be in service without maintenance. The filter membranes typically have pore sizes ranging from about 0.22 micrometers (μm) to 5 millimeters (mm) in diameter. The particular pore size and material is selected for compatibility with the specific fluid sample to be analyzed.

After passing through the phase selective filter, the fluid sample is substantially particle free and contains only the desired (i.e. lipid or aqueous phase) components. The processed sample is then optionally delivered to the ARS module 64, where the sample is further optionally processed for protein separation, denaturing, and other treatment. Once the sample has been processed through the ARS module 64, it flows to an analysis module 68, such as a High Performance Liquid Chromatography (HPLC) system, for analysis.

Flow of the fluid sample in the HSI is controlled by pump 16. In order for the pump to control the flow rate of the upstream fluid sample, the fluid channel 42 is initially filled, or “pre-filled,” with an incompressible fluid. This allows fluid pressure at the sampling source to be instantly transmitted downstream to the pump. The pump then controls the flow rate of the fluid by creating a pressure differential across the fluid channel.

For example, isolation valve 27 can shut off fluid communication between the alternating fluid line 41 and the fluid channel 42. Fluid channel 42 is then pre-charged by pumping an incompressible fluid from incompressible fluid source 19 to fill fluid channel 42. Upon commencing the filtering operation, isolation valve 27 reopens fluid communication between the alternating fluid line 41 and the fluid channel 42. This establishes a fluid/fluid interface between the fluid sample and the incompressible fluid at isolation valve 27. The pump 16 can then control the flow of the fluid sample by drawing in the incompressible fluid.

This method of flow control differs from that described in U.S. Patent Application Publication No. 2004-0259266. The method described in that publication does not pre-fill the fluid channel with an incompressible fluid. Instead, no fluid is initially present in the fluid channel, and fluid sample is freely allowed to flow under hydrostatic pressure from the fluid sample source until reaching the pump downstream.

To prevent clogging of the filters and contamination of the sample source and sampling apparatus, the apparatus is flushed with a cleaning fluid during a cleaning operation. Referring to FIG. 1, the cleaning fluid is pumped upstream (i.e. in a flow direction opposite the flow of fluid sample to the HSI) to the filters by pump 16. During the cleaning operation, 3-way valves 34, 32, and 30 can, in turn, shut the pathway to the sample source so that cleaning fluid sequentially passes through each of the filters and then to a waste drain.

For example, 3-way valve 34 closes fluid communication between phase selective filter 14 and phase neutral filter 12. Valve 34 also opens fluid communication between phase selective filter 14 and a waste drain. Pump 16 forces cleaning fluid from cleaning fluid reservoir 18 to pass through phase selective filter 14 in a flow direction opposite the flow direction of the fluid from the fluid source. As the cleaning fluid passes through phase selective filter 14, residue attached to the filter membrane of phase selective filter 14 breaks free and is flushed to the waste drain.

Once phase selective filter 14 is sufficiently cleared of residue, valve 34 reopens fluid communication between selective phase selective filter 14 and phase neutral filter 12. Valve 32 closes fluid communication between phase neutral filter 12 and phase neutral filter 10. Valve 32 also opens fluid communication between phase neutral filter 12 and the waste drain. Pump 16 then forces more cleaning fluid from cleaning fluid reservoir 18 to pass through filters 14 and 12, clearing particle residue from phase neutral filter 12 and flushing the residue to the waste drain.

After phase neutral filter 12 is sufficiently cleaned, valve 32 reopens fluid communication between phase neutral filter 12 and phase neutral filter 10. Valve 30 then closes fluid communication between phase neutral filter 10 and isolation valve 27, and opens fluid communication between phase neutral filter 10 and the waste drain. The flushing procedure is then repeated to clean phase neutral filter 10. When the cleaning operation has sufficiently cleaned the filters, the valves may be reoriented to allow the flow of fluid from the fluid source to pass through the filters in a subsequent filtering operation.

The cleaning cycle preferably uses a quantity of cleaning fluid larger than that sufficient to fill the volume of the fluid channel 42 and the filters. Typically, the amount used is at least three times the volume of the fluid channel and filters, so that the channel is completely flushed three times after each sampling operation. Preferably, the pump 16 should provide cleaning fluid in an amount at least five times the volume of the fluid channel. However, larger volumes of cleaning fluid can be used to flush highly viscous fluids from the fluid channel.

### Sampling Loop Module

Some fluid vessels include a recirculation line, such as recirculation line 28 of FIGS. 1 and 3, to stir the fluid. In such cases, recirculation line is connected to the sampling system via a sampling loop module. Referring to FIG. 3, sampling loop module 70 comprises sampling loop channel 24, reversible pump 22 controlled by programmable logic controller (PLC) 58, fluid ports 54 and 52, and sample loop tap 36.

As shown in FIG. 3, sampling loop channel 24 fluidly communicates with recirculation line 28 of the fluid vessel 26 at fluid ports 54 and 52. Fluid port 54 has a pre-filter 50, and thus is referred to as a “pre-filter fluid port.” Fluid port 52 has no pre-filter, and is referred to as a “filterless fluid port.” Reversible pump 22 circulates fluid through sampling loop channel 24, primarily in a “forward flow” direction, whereby the fluid enters sampling loop channel 24 through pre-filter fluid port 54 and returns to the fluid source through filterless fluid port 52. When the fluid flows in the forward flow direction, the pre-filter of fluid port 54 screens large solid particles from the fluid. A portion of the pre-filtered fluid can then be routed downstream through tap 36.

In another embodiment, fluid ports 54 and 52 interface the recirculation line 28 at a single location, as shown in FIG. 4. Fluid ports 54 and 52 of this embodiment are co-axial, thus providing facilitating quick removable connectivity between the fluid ports of the sampling loop and the recirculation line. Since the fluid ports in this embodiment are disconnectable, the pre-filter 50 is positioned within the sampling loop channel 24 near pre-filter fluid port 54, rather than directly at pre-filter fluid port 54. This particular configuration is suited for portable and temporary sampling interfaces with the sample source.

During circulation in the forward flow direction, solid particles are allowed to accumulate on the screen of the pre-filter, forming particle cake 56. To some extent, particle cake 56 assists in pre-filtering the fluid sample. In addition, the tangential flow of the fluid in recirculation line 28 inhibits rapid accumulation of particles on pre-filter 50. However, over time, particle cake 56 develops and impedes fluid flow. To address this issue, the sampling loop module is optionally equipped for periodic removal of particle cake 56.

At predetermined time intervals, reversible pump 22 reverses the flow of the fluid within the sampling loop channel 24 from a forward flow direction to a “reversed flow” direction. In the reversed flow direction, fluid enters sampling loop channel 24 through filterless fluid port 52 and exits through pre-filter fluid port 54. Reversed flow of the fluid forces particle cake 56 away from fluid port 54 and removes air from sampling loop channel 24. The particle cake 56 then returns to the sample source vessel 26 via the recirculation line 28 and is broken apart.

When reversible pump 22 operates in the reversed flow direction, non-pre-filtered fluid is allowed to enter the sampling loop channel through filterless fluid port 52. To prevent non-pre-filtered fluid from reaching sampling loop tap 36, reversible pump 22 operates in the reversed flow direction only for a duration insufficient for non-pre-filtered fluid to reach the sampling loop tap. In other words, the duration of reversed flow is significantly shorter than the duration of forward flow, and non-pre-filtered fluid is not allowed to enter the sampling loop tap. For example, a forward flow period can occur during 80% of a given cycle, while a reversed flow period can occur only 20% of the cycle (i.e. a forward duty cycle of 0.8). A cycle includes one forward flow period and one reversed flow period. Cycle timing of the reversible pump is controlled by controller 58 and is calculated to allow particle cake 56 to form to optimal dimensions. The total period of an entire cycle must be less then the residence time of the fluid sample in the sample loop channel 24, and the forward flow period must be greater than 50% of the total cycle period.

The reversible feature of the pump is an optional feature used in an embodiment of the invention. In the alternative, the sampling loop can use a conventional pump and the pre-filter and pre-filtering operation can be omitted from the sampling loop module.

### Alternating Fluid Module

Referring to FIG. 4, the sampling loop module 70 and HSI module 62 are optionally connected by an alternating fluid module 60. The alternating fluid module includes an alternating fluid line 41 that ties into the sampling loop channel 24 through tap 36. Referring to FIGS. 1 and 4, the alternating fluid module includes a check valve 23, a strainer 25, an alternating pump 21, and an isolation valve 27 positioned along alternating fluid line 41. Check valve 23 and isolation valve 27 separate and control fluid communication between the alternating fluid module 60 and the HSI module 62. Strainer 25 prevents solid particle clusters in the fluid sample from entering the HSI module 62. To break up solid particle clusters, alternating pump 21 can apply periodic back pressure to “jog” or agitate the fluid in the alternating fluid line 41 (i.e., reciprocate the direction of fluid flow in periodic cycles). Check valve 23 permits the fluid in the alternating fluid line 41 to enter the HSI module 62 and prevents fluid in HSI module 62 from flowing back into the alternative fluid module 60.

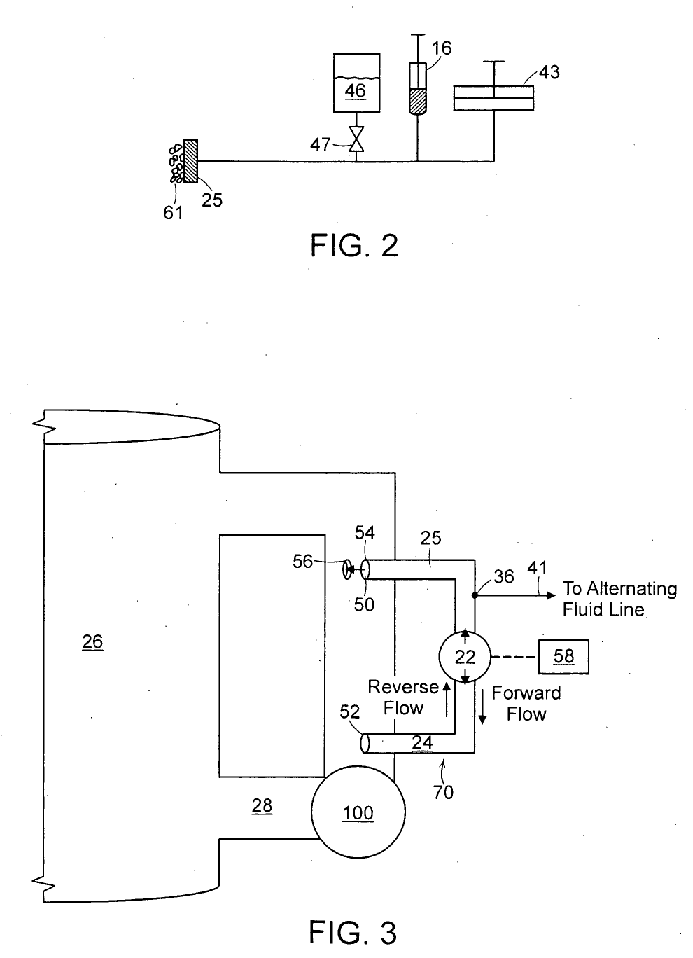

Alternating pump 21, can be any type of pressure source capable of reciprocating fluid within a fluid line. For example, suitable alternating pumps include vibrating diaphragm pump 21a, syringe pump 21b, and high pressure fluid source 21c in combination with a valve 47, as shown in FIG. 2. Alternating pump 21 preferably operates continuously. The reciprocation of the fluid occurs at a predetermined frequency and amplitude and breaks apart large agglomerated particles 61 that cannot pass through the strainer. The frequency and amplitude can be tuned to a particular fluid sample, based on the viscosity of the fluid.

Resident sample fluid in the sampling loop and alternating fluid modules can be flushed by additional sample fluid from the sample source 26. The flushing ensures that an entirely new sample is acquired during a subsequent sampling operation. During flushing, valve 30 is configured to allow the resident sample fluid to bypass the HSI module pass to the drain.

As described, the operations of the sampling loop module, alternating flow module, and HSI module in a fluid sampling system together achieve automatic, aseptic, extractive sampling of fluid samples from fluid sources containing high solids and/or high viscosity fluid without failing due to adverse interactions between the fluid and the sampling device, such as clogging or fouling due to mechanical means or to physiochemical reactions between the fluid and the materials of construction of the sample device.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus for filtering a fluid sample, comprising:
an inlet adapted for fluid communication with a fluid sample source;
a first valve positioned to receive the fluid sample from the inlet and coupled to a drain;
at least one phase neutral filter positioned to receive the fluid sample from the first valve to filter one or more solid components from the fluid sample;
a second valve positioned to receive the fluid sample from the phase neutral filter and coupled to the drain;
at least one phase selective filter positioned to receive the fluid sample from the second valve and to separate one of a hydrophilic phase and a hydrophobic phase from the fluid sample; and
an outlet.

2. The apparatus of claim 1, wherein the fluid sample is driven by a pump downstream of the phase selective filter.

3. The apparatus of claim 2, wherein the pump is a syringe pump.

4. The apparatus of claim 2, wherein the first valve, second valve, and pump are automatically controlled by a controller.

5. The apparatus of claim 1, wherein the inlet is in fluid communication with a fluid sample source.

6. The apparatus of claim 1, wherein the outlet is in fluid communication with an analysis module.

7. The apparatus of claim 1, wherein the outlet is in fluid communication with an incompressible fluid source.

8. The apparatus of claim 1, wherein the outlet is in fluid communication with a cleaning fluid source.

9. The apparatus of claim 1, wherein the valves are three-way valve devices.

10. The apparatus of claim 1, further comprising a second phase selective filter positioned in parallel with the phase selective filter.

11. An apparatus for filtering a fluid sample from a fluid sample source, comprising: at least one phase neutral filter to filter one or more solid components from the fluid sample and at least one phase selective filter to separate one of a hydrophilic phase and hydrophobic phase from the fluid sample, the phase neutral filter preceding the phase selective filter along a fluid channel with respect to the fluid sample source.

12. A sampler for acquiring fluid samples from a fluid sample source, comprising:
a sampling loop channel having a first fluid port adapted for fluid communication with the fluid sample source and a second fluid port adapted for fluid communication with the fluid sample source;
a pre-filter to filter solid particles from the fluid;
a reversible pump along the sampling loop channel; and
a sampling tap in the sampling loop channel.

13. The sampler of claim 12, wherein the reversible pump is controlled by an automated controller.

14. The sampler of claim 13, wherein the automated controller cycles the pump in forward and reverse directions with fluid drawn into the sampling loop channel through the pre-filter at a sufficient forward duty cycle to maintain a pre-filtered sample at the tap.

15. An apparatus for breaking up solid particle clusters in a fluid sample, comprising:
an inlet that receives the fluid sample from a fluid sample source;
a strainer that receives the fluid sample from inlet;
a check valve that receives fluid from the strainer; and
a pressure source between the strainer and the check valve that reciprocates a flow direction of the fluid sample through the strainer.

16. A system for sampling a fluid sample comprising:
a sampling loop channel having a first fluid port adapted for fluid communication with the fluid sample source and a second fluid port adapted for fluid communication with the fluid sample source;
a pre-filter to filter solid particles from the fluid;
a reversible pump along the sampling loop channel;
a sampling tap in the sampling loop channel;
a strainer that receives the fluid sample from the sampling tap;
a check valve that receives fluid from the strainer;
a pressure source between the strainer and the check valve that reciprocates a flow direction of the fluid sample through the strainer;
a first valve positioned to receive the fluid sample from the check valve and coupled to a drain;
at least one phase neutral filter positioned to receive the fluid sample from the first valve to filter one or more solid components from the fluid sample;
a second valve positioned to receive the fluid sample from the phase neutral filter and coupled to the drain; and
at least one phase selective filter positioned to receive the fluid sample from the second valve to separate one of a hydrophilic phase and a hydrophobic phase from the fluid sample.

17. A method for filtering a fluid sample from a fluid sample source, comprising the steps of: passing the fluid sample through at least one phase neutral filter to filter one or more solid components from the fluid sample and then passing the fluid sample through at least one phase selective filter to separate one of a hydrophilic phase and a hydrophobic phase from the fluid sample.

18. The method of claim 17, wherein the fluid sample passes through the phase neutral filter and the phase selective filter along a fluid channel.

19. The method of claim 18, further comprising the steps of:
prefilling the fluid channel with an incompressible fluid;
opening fluid communication between the fluid channel and the fluid sample source; and
allowing the fluid sample to pass through the filters by controlling the flow rate of the incompressible fluid through the fluid channel.

20. A method of claim 18, further comprising the steps of:
closing fluid communication between the fluid channel and the fluid sample source;
allowing the cleaning fluid to flow through the phase selective filter along the fluid channel to a drain, the cleaning fluid flowing in a direction opposite a flow direction of the fluid sample from the fluid sample source to flush residue from the phase selective filter; and
allowing the cleaning fluid to flow through the phase neutral filter along the fluid channel to a drain, the cleaning fluid flowing in a direction opposite a flow direction of the fluid sample from the fluid sample source to flush residue from the phase neutral filter.

21. A method for pre-filtering a fluid sample comprising the steps of:
circulating a fluid sample from a fluid sample source through a sampling loop channel having a pre-filter in a forward flow direction, the fluid sample entering the sampling loop channel through a first fluid port and returning to the fluid sample source through a second fluid port;
allowing solid particle clusters from the fluid sample to accumulate on the pre-filter as the fluid sample is circulated in the direction of forward flow; and
removing the accumulated solid particles on the pre-filter by reversing the flow direction for a duration insufficient for a non-pre-filtered fluid sample to reach a sampling tap in the sampling loop channel.

22. A method for breaking up solid particles in a fluid sample, comprising the steps of:
allowing a fluid sample to enter a fluid line having a strainer; and
reciprocating a flow direction of the fluid sample.

23. The method of claim 22, wherein the flow direction of the fluid sample is reciprocated by a syringe.

24. The method of claim 22, wherein the flow direction of the fluid sample is reciprocated by a diaphragm pump.

25. The method of claim 22, wherein the flow direction of the fluid sample is reciprocated by a high pressure fluid source and a valve.

26. A method comprising the steps of:
prefilling a fluid channel with an incompressible fluid;
opening fluid communication between the fluid channel and a fluid sample source;
allowing a fluid sample to flow into the fluid channel by controlling the flow rate of the incompressible fluid through the fluid channel;
passing the fluid sample through a phase neutral filter along the fluid channel to filter one or more solid components from the fluid sample;
passing the fluid sample through a phase selective filter along the fluid channel to filter one of a hydrophilic phase and a hydrophobic phase from the fluid sample;
passing the fluid sample to an analysis module;
closing fluid communication between the fluid channel and the fluid sample source;
allowing a cleaning fluid to flow through the phase selective filter along the fluid channel to a drain the cleaning fluid flowing in a direction opposite a flow direction of the fluid sample from the fluid sample source, to flush residue from the phase selective filter; and
allowing the cleaning fluid to flow through the phase neutral filter along the fluid channel to a drain, the cleaning fluid flowing in a direction opposite a flow direction of the fluid sample from the fluid sample source, to flush residue from the phase neutral filter.

27. A method comprising the steps of:
circulating a fluid sample from a fluid sample source through a sampling loop channel having a pre-filter in a direction of forward flow, the fluid sample entering the sampling loop channel through a first fluid port and returning to the fluid sample source through a second fluid port;
allowing solid particles from the fluid sample to accumulate on the pre-filter as the fluid sample is circulated in a flow direction;
removing the accumulated solid particles on the pre-filter by reversing the flow direction for a duration insufficient for a non-pre-filtered fluid sample to reach a sampling tap in the sampling loop channel;
allowing pre-filtered fluid sample to enter a fluid line through a sampling tap, the fluid line having a strainer;
reciprocating the flow direction of the fluid sample;
allowing the fluid sample to flow into the fluid channel by controlling the flow rate of an incompressible fluid through the fluid channel;
passing the fluid sample through a phase neutral filter along the fluid channel to filter one or more solid components from the fluid sample;
passing the fluid sample through a phase selective filter along the fluid channel to filter one of a hydrophilic phase and a hydrophobic phase from the fluid sample;
passing the fluid sample to an analysis module;
allowing a cleaning fluid to flow through the phase selective filter along the fluid channel to a drain, the cleaning fluid flowing in a direction opposite a flow direction of the fluid sample from the fluid sample source, to flush residue from the phase selective filter; and
allowing the cleaning fluid to flow through the phase neutral filter along the fluid channel to a drain, the cleaning fluid flowing in a direction opposite a flow direction of the fluid sample from the fluid sample source, to flush residue from the phase neutral filter.
